(19) United States
(12) Patent Application Publication
(10) Pub. No.: US 2016/0021507 A1
(43) Pub. Date: Jan. 21, 2016

(54) SYSTEM AND METHOD FOR PROVIDING IN REAL-TIME SUBSTANTIALLY ACCURATE WAIT-TIMES AT DIFFERENT LOCATIONS

(71) Applicant: Scott Gaines, O'fallon, IL (US)

(72) Inventor: Scott Gaines, O'fallon, IL (US)

(21) Appl. No.: 14/335,980

(22) Filed: Jul. 21, 2014

(51) Int. Cl. H04W 4/02; H04W 4/20; H04W 4/00

(52) U.S. Cl. CPC H04W 4/028; H04W 4/023; H04W 4/008; H04W 4/206

(57) ABSTRACT

A system and method are described for providing wait-time information regarding a location by a user. An actual wait-time experienced at the location by the user is determined and is reported using a wait-time reporting software application (App) substantially soon after the waiting period has ended to a wait-time server by the user using a mobile communication device upon which is stored the wait-time reporting software App. The actual wait-time can then be provided by the wait-time server to one or more requestors upon request to their respective one or more electronic devices. The actual wait-time can be an estimated wait time, estimated in different manners by the user or another person, or the actual wait-time can be determined using a time, or geographical tracking mechanism. In addition, the users can choose to report their wait-times to selection others in different manners (social media, among other reporting mechanisms).

### TECHNICAL FIELD

The embodiments described herein relate generally to methods and apparatuses for conducting a wireless informational transaction that is user friendly.

### BACKGROUND

In recent years, the use of personal electronic devices in many different aspects of our modern lives has occurred. It was not long ago when a “personal electronic device” first meant a portable AM radio, then an AM/FM radio, followed by a cassette tape player, and eventually compact music disc players. While useful and enjoyable, the majority of these devices were related to pleasure, or recreational use. Then, in the late 1980's and early 1990's, cellular telephone devices became or started to become nearly ubiquitous and then “mobile electronic device” became so much more. Of course, the use of a portable phone does entail personal/recreational use, but the business aspects of the device (other than the sale of the devices) became readily apparent: business could be conducted practically anytime, anywhere. Eventually, music, photographs, video images, data, positioning information (i.e., global positioning system (GPS) information) and, of course voice, all became integrated into a single type of device, now known as the “smart phone.”

Even more recently, the smart phone changed again, albeit perhaps less radically. The use of “Apps” (short for “applications”) has added a new dimension to the smart phone experience. Apps are available to track calorie consumption, act as stopwatches and timers, to provide instantaneous weather information, and a myriad other uses, some perhaps whimsical, others of unquestionable practical usefulness. For example, there are Apps that provide for easier methods of payment for goods and services (an App and a credit card reader device can be connected to a smart phone so that even Girl Scouts selling cookies can take credit cards!), and for exchanging of data between smart phones (which can be quite useful at business meetings, as well as exchanging email information, or photos of your children).

Further to this end, there are Apps and other systems that provide for determinations of waiting times at public use facilities (or “locations”), such as airports, restaurants, arenas, and the like. For example, U.S. Published Patent Application No. 2013/0297551 by Smith et al., describes a method and system that includes extracting event models from at least one personal planning source of a user, wherein a parameter of an event model includes event location, periodically receiving location information of at least one mobile device of the user, and storing the location information in a location log. The method and system of Smith further includes a pattern worker module for maintaining user location patterns through the location log, and generates a location prediction from the extracted event models and the user location patterns. The system and method of Smith also includes a first content worker module that checks if the location prediction meets a set of content requirements: if the set of content requirements is satisfied, it initiates content retrieval from at least one service, and then pushes the content to the mobile device.

U.S. Pat. No. 7,752,146 to Lert Jr., describes a system and method for integrating multiple customer ordering channels into a single service queue to obtain goods or services from a provider that includes enabling customers to request service for goods, or services from the provider using multiple ordering channels, and arranging the service requests placed using the ordering channels in a single service queue based on the time at which each is placed regardless of the ordering channel used. The ordering channels may include one or more ticket dispensers that dispenses tickets having the next number in the service queue to waiting customers, one or more computerized ordering systems that enable ordering of goods or services from the provider via a computer or other processing device, and combinations thereof.

Another system and method is described in Korean Patent Document 20130041434 by Lee, in which a service reservation and waiting sequence-providing system using a smart phone and quick response code is provided. The system and method provides the alleged benefit to the user of the smart phone (i.e., “client”) of allegedly avoiding excessive waiting lines through a waiting line inquiry. Based on the provided wait-times, the client can make informed decisions as to which lines to join. According to Lee, the system installation cost is relatively inexpensive to the service provider and it efficiently disperses the waiting line and enhances the total service usage availability ratio, which improves the profitability of the service provider.

There are certain problems, however, with each of the systems and method described above for determinations of waiting times at places such as airports, restaurants, arenas, and the like. Accordingly, it would be desirable to provide methods, modes and systems for providing near instantaneous and accurate waiting times at different location that can include public establishments, such as restaurants, airports, arenas, and the like, semi-public locations, such as certain government functions, and the like, and private locations, such as an art gallery, parties, and the like.

### SUMMARY

An object of the embodiments is to substantially solve at least the problems and/or disadvantages discussed above, and to provide at least one or more of the advantages described below.

It is therefore a general aspect of the embodiments to provide methods, modes and systems for providing near instantaneous and accurate waiting times at different locations that will obviate or minimize problems of the type previously described.

According to a first aspect of the embodiments, a method for providing wait-time information regarding a location by a user is provided, the method comprising determining an actual wait-time experienced at the location by the user, reporting the actual wait-time using a wait-time reporting software application (App) substantially soon after a waiting period has ended to a wait-time server by the user using a mobile communication device upon which is stored the wait-time reporting software App, and providing the actual wait-time by the mobile communications device to one or more requestors upon request to their respective one or more electronic devices. According to the first aspect of the embodiments, the step of determining an actual wait-time comprises estimating the wait-time waiting at the location. Still further according to the first aspect, the step of estimating an actual wait-time comprises estimating a wait-time by the user before experiencing the wait-time, estimating a wait-time by the user after experiencing the wait-time, obtaining an estimated wait-time provided by another person before the another person has experienced the wait-time, or obtaining an estimated wait-time provided by another person after the other person has experienced the wait-time.

According to the first aspect of the embodiments, the step of determining an actual wait-time comprises starting a timer at a beginning of the wait-time using the mobile electronic communication device, and stopping the timer at an end of the wait-time. Still further according to the first aspect, the step of determining an actual wait-time comprises obtaining an actual wait-time experienced by another person, or determining the wait-time based on a change in a geographical position as determined by geographical position information generated by a geographical position determining system and provided to the wait-time reporting software App stored on the user's mobile electronic communication device, wherein the wait-time reporting software App is configured to calculate an actual wait-time based on the geographical position information provided by the geographical position determining system. According to the first aspect of the embodiments, the geographical position determining system is one based on at least one of a near field communications system, a Bluetooth communications system, and a Wi-Fi communications system, or the geographical position determining system is one based on at least one of a global positioning system, and a cellular phone network system.

According to a second aspect of the embodiments, a method for maintaining a wait-time information database on a wait-time server is provided, the method comprising receiving a location name message from an electronic device, wherein the location name message contains at least a location name where a user is or will be waiting, determining a registration status of the electronic device with the wait-time server, and if not registered, determining whether registration is desired, verifying the name and geographical position of the location through one or more of a location name database stored at the wait-time server and other electronically accessible searchable databases, determining whether a social networking website should be updated when the wait-time information is received, and receiving and storing the wait-time information from the electronic device.

According to a third aspect of the embodiments, a method for accessing wait-time information from a wait-time database on a wait-time server is provided, the method comprising receiving a request by an electronic device using an electronic communications system to access the wait-time server to obtain a desired wait-time information about a first location, determining a registration status of the electronic device with the wait-time server, and if not registered, determining whether registration is desired, and providing the desired wait-time information about the first location to the electronic device, wherein a quality of the wait-time information can be made dependent upon the registration status.

According to a fourth aspect of the embodiments, a system for providing wait-time information regarding a location by a user is provided, the system comprising a first mobile electronic communications device containing a wait-time reporting software application (App) configured to capture and transmit actual wait-time information at the location substantially soon after a waiting period has ended, a second electronic device configured to receive the actual wait-time information and store the same, and wherein the second electronic device is further configured to provide the actual wait-time information upon request.

According to the fourth aspect, the actual wait-time comprises an estimation of the wait-time while waiting at the location. According to the further aspect of the embodiments, the estimated wait-time is estimated by the user before experiencing the wait-time, the estimated wait-time is estimated by the user after experiencing the wait-time, the estimated wait-time is provided by another person before the another person has experienced the wait-time, or the estimated wait-time is provided by another person after the another person has experienced the wait-time.

According to the fourth aspect of the embodiments, the system further comprises a timer configured to be used with the mobile electronic communications device, wherein the use can start the timer at a beginning of the wait-time and stop the timer at an end of the wait-time. According to the fourth aspect, the actual wait-time is obtained from another person after the another person has experienced the wait-time, or the actual wait-time is determined based on a change in a geographical position as determined by geographical position information generated by a geographical position determining system and provided to a wait-time reporting software App stored on the user's mobile electronic communication device, wherein the wait-time reporting software App is configured to calculate an actual wait-time based on the geographical position information provided by the geographical position determining system. According to the fourth aspect, the geographical position determining system is one based on at least one of a near field communications system, a Bluetooth communications system, and a Wi-Fi communications system, or the geographical position determining system is one based on at least one of a global positioning system, and a cellular phone network system.

According to a fifth aspect of the embodiments, a system for maintaining a wait-time information database is provided, the system comprising a wait-time server including memory, and containing wait-time software stored in the memory, the wait-time software configured to receive a location name message from an electronic device, wherein the location name message contains at least a location name where a user is or will be waiting, and wherein the wait-time software is further configured to determine a registration status of the electronic device with the wait-time server, and if not registered, determine whether registration is desired, verify the name and geographical position of the location through one or more of a location name database stored at the wait-time server and other electronically accessible searchable databases, determine whether a social networking website should be updated when the wait-time information is received, and receive and store the wait-time information from the electronic device.

According to a sixth aspect of the embodiments a system for providing wait-time information is provided, the system comprising a wait-time server that includes memory, and the memory containing wait-time software stored therein. The wait-time software is configured to receive a request by an electronic device using an electronic communications system to access the wait-time server to obtain a desired wait-time information about a first location, and the wait-time software is further configured to determine a registration status of the electronic device with the wait-time server, and if not registered, determining whether registration is desired and provide the desired wait-time information about the first location to the electronic device, wherein a quality of the wait-time information can be made dependent upon the registration status.

According to a seventh aspect of the embodiments, a method for operating a wait-time information distribution service is provided, the method comprising receiving one or more location name messages from one or more electronic devices, wherein each of the one or more location name messages contains at least a location name of a first location where a user is or will be waiting, verifying the location name and geographical position of the location through one or more of a location name database stored on the wait-time server and other electronically accessible searchable databases, receiving and storing actual wait-time information from one or more of the electronic devices regarding respective same or different locations, receiving a request by an electronic communications system to access the wait-time server to obtain a desired wait-time information about a first location, and providing the desired wait-time information about the first location to the requestor using the electronic communications system.

According to the seventh aspect of the embodiments, the method further comprises verifying the location name and geographical position of the location through one or more of a location name database stored on the wait-time server and other electronically accessible searchable databases, determining a registration status of a user of the one or more electronic devices with the wait-time server from which the one or more location name messages has been received, and if not registered, determining whether registration is desired, and determining whether a social networking website should be updated when the wait-time information is received from a registered user of the wait-time information distribution service.

According to an eighth aspect of the embodiments, a wait-time information distribution service is provided comprising one or more electronic devices configured to provide one or more location name messages, wherein each of the one or more location name messages contains at least a location name of a first location where a user is or will be waiting, and a wait-time information distribution server configured to verify the location name and geographical position of the location through one or more of a location name database stored on the wait-time server and other electronically accessible searchable databases, receive and store actual wait-time information from the one or more of the electronic devices regarding respective same or different locations, receive a request using an electronic communications system to access the wait-time server to obtain a desired wait-time information about a first location, and provide the desired wait-time information about the first location to the requestor using the electronic communications system.

### BRIEF DESCRIPTION OF THE DRAWINGS

The above and other objects and features of the embodiments will become apparent and more readily appreciated from the following description of the embodiments with reference to the following figures, wherein like reference numerals refer to like parts throughout the various figures unless otherwise specified, and wherein:

FIG. 1 is a high level block diagram depicting a general environment in which one or more users can use a system and method for providing or accessing near real-time, substantially accurate, wait-time information regarding waiting periods at different locations according to an embodiment;

FIG. 2 illustrates a network system within which the system and method for providing or accessing near real-time, substantially accurate, wait-time information regarding waiting periods at different locations can be implemented according to an embodiment;

FIG. 3 illustrates a functional block diagram of a mobile device for use with the system and method for providing or accessing near real-time, substantially accurate, wait-time information regarding waiting periods at different locations according to an embodiment;

FIG. 4 is a flow diagram illustrating a method of using one aspect of the system and method for providing or accessing near real-time, substantially accurate, wait-time information regarding waiting periods at different locations in a mobile device according to an embodiment;

FIG. 5 illustrates a flow diagram illustrating a method of maintaining wait-time information according to an aspect of the embodiments;

FIG. 6 illustrates a flow diagram illustrating a method of accessing wait-time information maintained according to the method of FIG. 5 by a user of a mobile device in a non-limiting example according to an embodiment;

FIG. 7 illustrates a functional block diagram of the WaitIQ server shown in FIG. 2 showing various functional blocks according to an embodiment;

FIG. 8 illustrates a block diagram of a short distance positioning determination system for use with the methods and apparatus to determine wait-time information according to an embodiment; and

FIGS. 9 and 10 illustrate, respectively, different screen shots that can be displayed on a mobile device used to enter or access substantially accurate, and in near real time wait-time information according to an embodiment.

### DETAILED DESCRIPTION

The embodiments are described more fully hereinafter with reference to the accompanying drawings, in which aspects of the embodiments are shown. In the drawings, the size and relative sizes of layers and regions may be exaggerated for clarity. Like numbers refer to like elements throughout. The embodiments may, however, be embodied in many different forms and should not be construed as limited to the embodiments set forth herein. Rather, these embodiments are provided so that this disclosure will be thorough and complete, and will fully convey the scope of the concept to those skilled in the art. The scope of the embodiments is therefore defined by the appended claims.

Reference throughout the specification to “one embodiment” or “an embodiment” means that a particular feature, structure, or characteristic described in connection with an embodiment is included in at least one aspect of the embodiments. Thus, the appearance of the phrases “in one embodiment” on “in an embodiment” in various places throughout the specification is not necessarily referring to the same embodiment. Further, the particular feature, structures, or characteristics may be combined in any suitable manner in one or more embodiments.

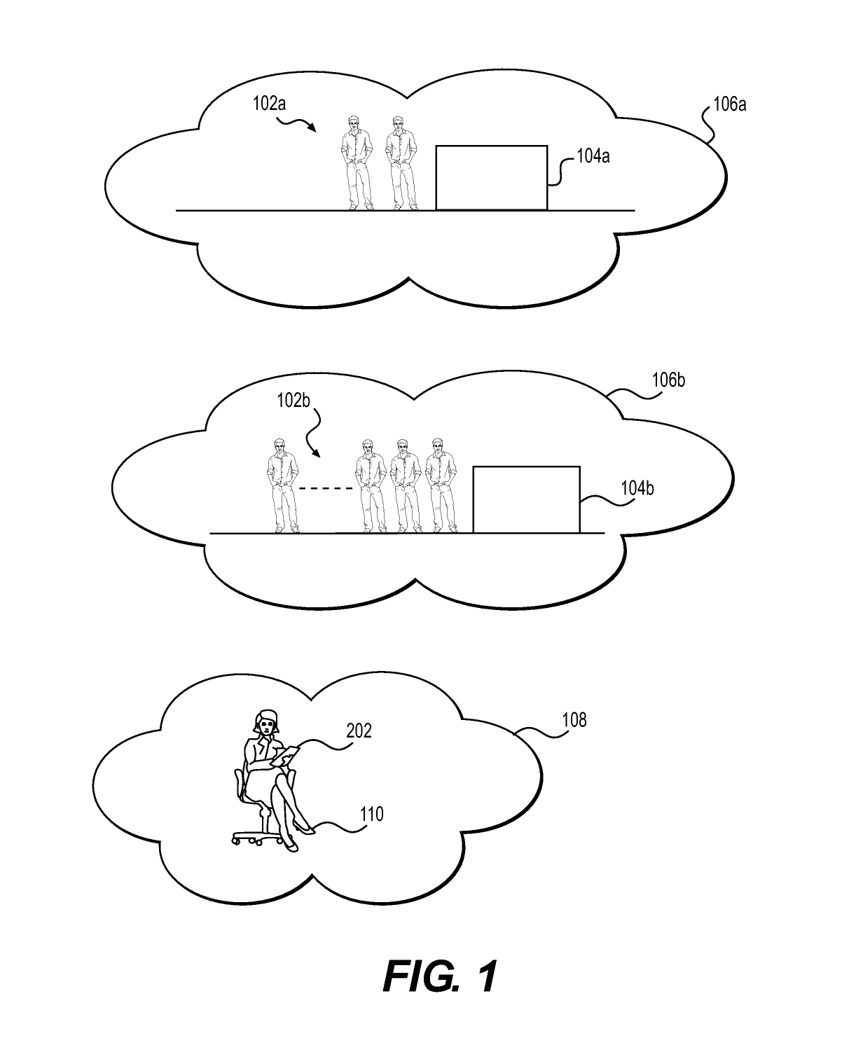

FIG. 1 is a high level block diagram depicting a general environment in which one or more users can use a system and method for providing or accessing near real-time, substantially accurate, wait-time information regarding waiting periods at different locations according to an embodiment (from hereon in, the “place” or “different location” about which the wait-time information is collected and/or determined will be simply referred to as the “location”). FIG. 1 shows several different views of one non-limiting use of the system and method according to different aspects of the embodiments. That is, according to embodiments, use of the system and method enables a user to ascertain substantially accurately, and nearly in real-time, what the actual wait-time is for different locations.

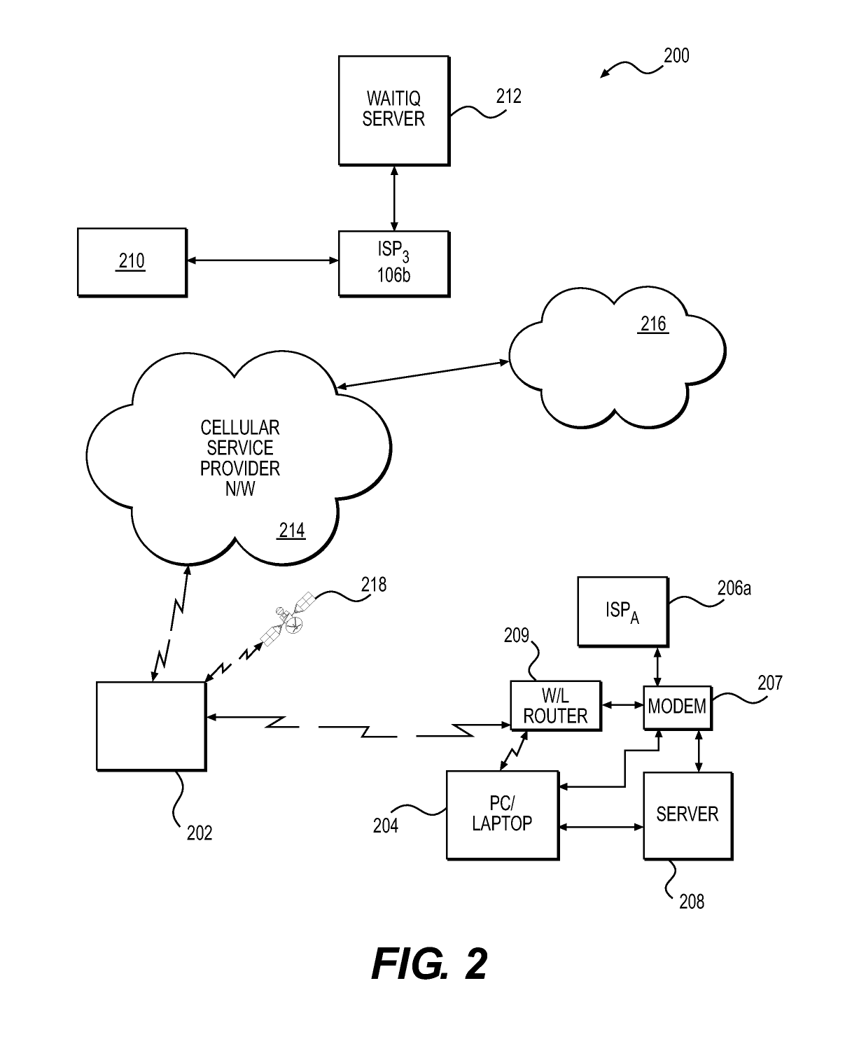

In FIG. 1, waiting customers 102a are waiting at restaurant 104a in environment 106a to get a seat for dinner. Since there are only a few waiting customers 102a in line, it would be expected that their wait-time would be relatively short, or at least shorter than waiting customers 102b, of which there are many more, who are waiting to eat at restaurant 104b. Presuming that one or more of waiting customers 102a and waiting customers 102b were users of the system and method for providing in near real-time substantially accurate wait-times at locations, they could then enter their actual wait-times into a wait-time database, managed by the system according to embodiments (and discussed in greater detail in regard to FIG. 2) for processing and use thereby. By use, it is meant according to embodiments that other users of the system and method can access the wait-time information, usually via an App on their smartphone (but can also be an App on a standard personal computer, or tablet, or via a website), and make an informed decision in regard to an actual wait-time at each of restaurants 104a, 104b. It might be that deciding customer 110 believes that restaurant 104b is worth the extra time, and so they engage waiting there regardless of the extra length of time. Or, conversely, deciding user 110 can decide that for whatever reason that the extra wait for restaurant 104b is not worth it, and therefore they will go to restaurant 104a to dine. In either case, using the system and method according to embodiments, users can make informed decisions about how best to spend their time, thereby preserving valuable resources.

By just this one brief, non-limiting example, several advantageous aspects of the embodiments are evident. First, and most readily apparent, less time can be wasted waiting in line through use of the embodiments. Deciding customer 110, if not so pre-disposed to go to restaurant 104b, would normally probably want to choose restaurant 104a, because of the shorter wait-time. Second, by predetermining before leaving home, or the office, that restaurant 104a is the preferred choice because of the shorter wait-time, this lessens or eliminates wasted gas or other travel costs going to a place where you otherwise would not have gone had you known that the wait-time exceeded whatever your personal limit is. As can be appreciated by those of skill in the art, use of the system and method according to an embodiment need not be limited to just restaurants. Determining an accurate, near real-time wait-time can be useful when deciding on a movie, or other live entertainment venues, bars, dancing venues, sporting events, airline ticket counters, among many other different locations. As those of skill in the art can further appreciate, the methods, modes and systems according to the various and different aspects of the embodiments are not limited to public locations only, but can be private ones as well, such as “by-invitation only” event (such as semi-public events, e.g., an opening of an art gallery, official government function, or completely private events such as parties, private demonstrations, among other kinds of gatherings).

FIG. 2 illustrates network system 200 within which the system and method for providing or accessing near real-time, substantially accurate, wait-time information regarding waiting periods at different locations can be implemented according to an embodiment. Much of the network system infrastructure shown in FIG. 2 is or should be known to those of skill in the art, so, in fulfillment of the dual purposes of clarity and brevity, a detailed discussion thereof shall be omitted.

According to an embodiment, a user of the system and method for providing in near real-time substantially accurate wait-times at different locations (hereinafter referred to as “system and method for providing wait-time information”) would have an App on their mobile device 202; mobile devices 202 can include, but are not limited to, so-called smart phones, tablets, personal digital assistants, notebook and laptop computers, and essentially any device that can access the internet and/or cellular phone service or can facilitate transfer of the same type of data in either a wired or wireless manner. For purposes of this discussion, the user shall be discussed as using only mobile device 202, i.e., a smartphone, though such discussion should be understand to be in a non-limiting manner in view of the discussion above about the other types of devices that can access, use, and provide such information.

In FIG. 2, the user has mobile device 202, which can access cellular network 214, either through a wireless or wired interconnection. Further, as discussed below in greater detail, mobile device 202 can have near field communication (NFC), “Wi-Fi,” and Bluetooth (BT) communications capabilities as well. To that end, network system 200 further includes, as many homes (and businesses) do, server 208 and/or laptop/personal computer (PC) 204 which can be connected to wireless router (router) 209 via a wired or wireless connection. Also shown in FIG. 2 is modulator-demodulator (MODEM) 207, which is connected to ISP 206, and provides signals in the appropriate format to end users, and which takes signals from the end users and forwards them to ISP 206. As those of skill in the art can appreciate, mobile device 202 can access cellular network 214 either directly wirelessly, or via router 218, through PC 204 and/or server 208 and the internet service provider 206a and internet 216. Such communication pathways are well known and understand by those of skill in the art, and further detailed discussion thereof is thus unnecessary.

Mobile device 202 can also access global positioning system 218, to obtain positioning information (useful for different aspects of the embodiments, discussed in greater detail below), or can obtain positioning information via cellular service provider 214 according to one or more well-known methods of position determination. Some mobile devices 202 can also access satellites (not shown) for near-universal communications capabilities, albeit at a much higher cost than convention “terrestrial” cellular services. Mobile device 202 can also obtain positioning information internal to a building (or arena/stadium) through the use of one or more NFC/BT devices, the details of which are discussed below.

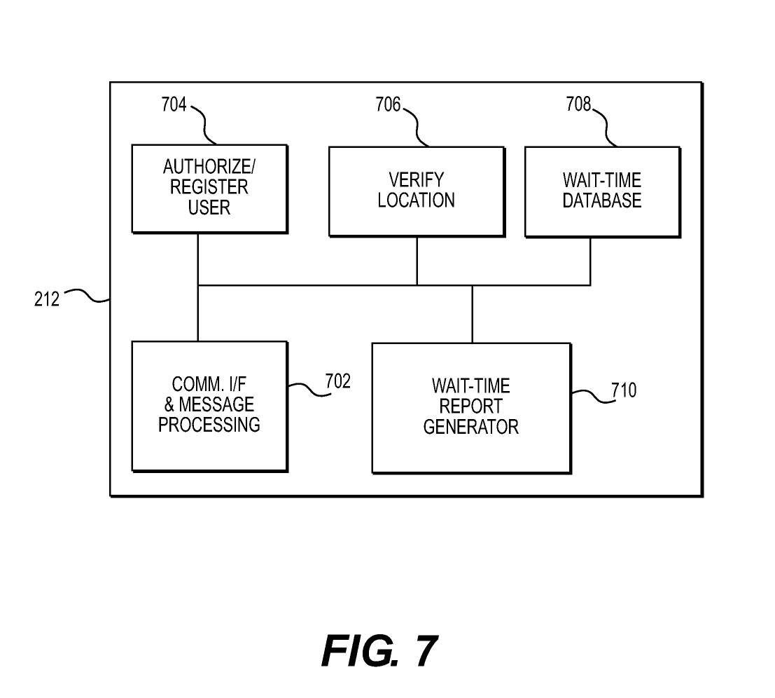

FIG. 2 also illustrates other components of network system 200 such as phone service provider 210, a second ISP 208b, and WaitIQ server 212, wherein one or more processors, using known and understood technology, such as memory, data and instruction buses, and other electronic devices, can store and implement code that can implement the system and method for providing wait-time information according to an embodiment. WaitIQ server 212 is discussed in greater detail below, in regard to FIG. 7.

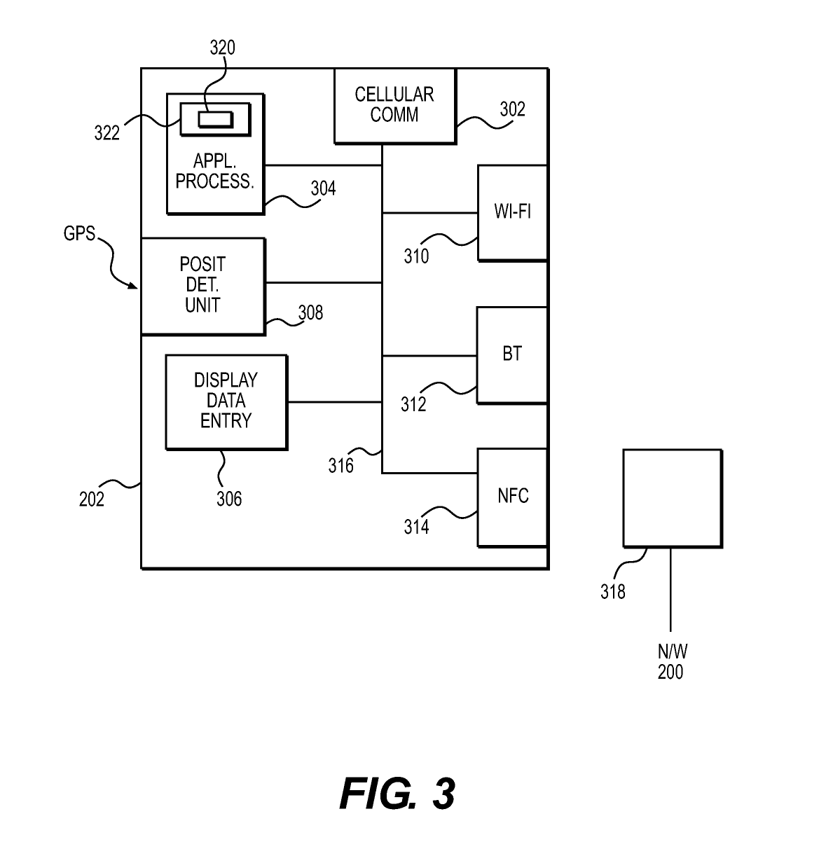

FIG. 3 illustrates a functional block diagram of mobile device 202 for use with the system and method for providing or accessing near real-time, substantially accurate, wait-time information regarding waiting periods at different locations according to an embodiment. In the following description, numerous specific details are set forth to provide a thorough understanding of the concepts underlying the described embodiments. It will be apparent, however, to one skilled in the art that the described embodiments may be practiced without some or all of these specific details. In other instances, well known process steps have not been described in detail in order to avoid unnecessarily obscuring the underlying concepts.

FIG. 3 shows mobile device 202 that includes position determining unit 312 configured to ascertain and verify a position of a user of mobile device 202 for use with the system and method for providing wait-time information according to embodiments. Mobile device 202 also includes application processor (AP) 304 that executes applications to, for example, notify WaitIQ server 212 about actual wait-times experienced by the user of mobile device 202, verify location information of the user and mobile device 202, and provide the same to WaitIQ server 212, and to allow the user of mobile device 202 to access accumulated and processed wait-time information about a plurality of different locations from WaitIQ server 212 in order to make an informed, intelligent choice as to when or whether to visit any one of the plurality of different locations. Such applications are stored in the form of code, or computer enabling instructions, stored in one or many different types of memory (discussed in greater detail below) 322. According to an embodiment, one such application (App) is WaitIQ App 320; WaitIQ App 320 is an application that can be stored on one or more of a mobile phone, PC, laptop, server, tablet, or any other portable or non-portable electronic device capable of accessing WaitIQ server 212 and that interfaces with and access the WaitIQ program stored therein, in a manner well known to those of skill in the art.

Mobile device 202 also includes one or more air interfaces, such as near field communications (NFC) 314, Wi-Fi 310 (e.g., wireless local area network (WLAN) products that are based on the Institute of Electrical and Electronics Engineers' (IEEE) 802.11 standard), and Bluetooth (BT) 312. NFC 314, and cellular communications transceiver 302 (using third generation (3G), fourth generation (4G or long term evolution (LTE)) communication protocols), can communicate with WaitIQ server 212 as described above, through the different networks. Bluetooth 112, Wi-Fi 310, and cellular protocols are wireless communication protocols.

According to an embodiment, user of mobile device 202 can provide wait-time information and/or position information by using NFCs to wirelessly establish a secure link with the location communication interface (LCI) 318, if available, which can be connected to network 200 that is configured to route the wait-time and/or position information to WaitIQ server 212. This link, which can be secure or not, can be established using NFC 314 by positioning mobile device 202 to be within close proximity of LCI 318 (e.g., 3-6 cm).

As can be appreciated by those of skill in the art, however, LCI 318 is not limited to NFC transmissions, but can include BT and Wi-Fi and wireless communications; in any case, the data from mobile device 202 can be transmitted to LCI 318 and then communicated to WaitIQ server 212 using known methods and manners of communications, the detailed discussion of which is not necessary for understanding the embodiments described herein. Or, data from mobile device 202 can be transmitted directly to cellular service provider 114 via cellular communication interface 302, and then get routed to WaitIQ server 212.

Mobile device 202 further includes display/data entry unit 306 that is commonly in the form of a touchscreen display in many of the currently available mobile devices 202. Data/command bus 316, which is shown in a greatly simplified form in FIG. 3, transfers data to and from the various communication interfaces, as well as to and from application processor 304, position determining unit (PDU) 308, and display/data entry unit 306. It is further understood by those of skill in the art that each of the communication interfaces, i.e., cellular communications interface 302, Wi-Fi 310, BT 312, NFC 314 and PDU 308, can have their own or shared antennas, which have been omitted from FIG. 3 for the sake of clarity and precision.

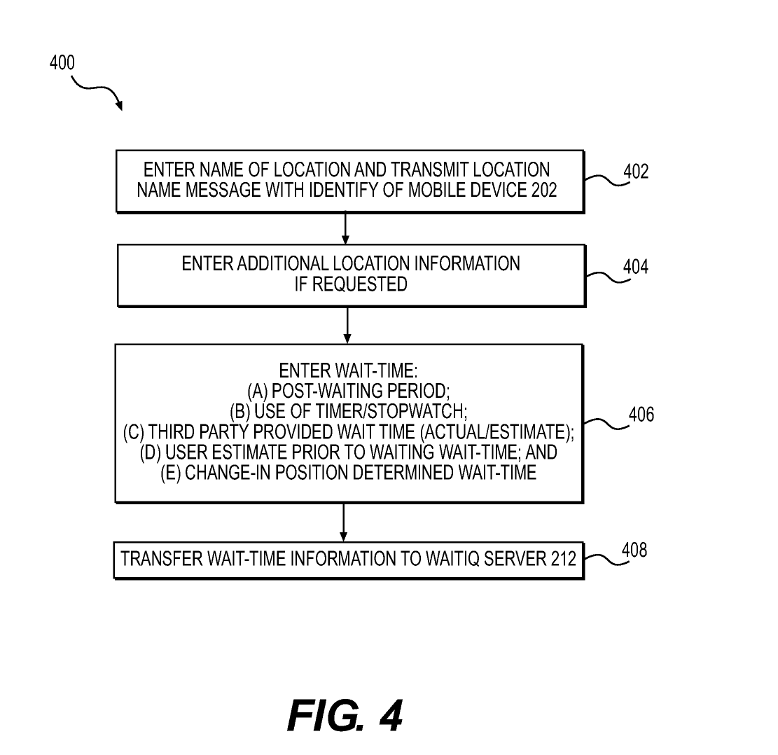

FIG. 4 is a flow diagram illustrating method 400 of using one aspect of the system and method for providing or accessing near real-time, substantially accurate, wait-time information regarding waiting periods at different locations in mobile device 202 according to an embodiment. An encoding process is discussed with reference to FIG. 4. This encoding process is not meant to limit the embodiments, nor to suggest that any particular embodiment should be implemented following this encoding process. The purpose of the following encoding process is to facilitate the understanding of an embodiment and to provide the reader with one of many possible implementations of the processes discussed above and below. FIG. 4 shows a flow chart illustrating various steps performed during the encoding process. The steps shown in FIG. 4 are not intended to completely describe the encoding process but only to illustrate some of the aspects discussed above, nor should they be construed to indicate that any particular order of steps needs to occur, unless otherwise so indicated.

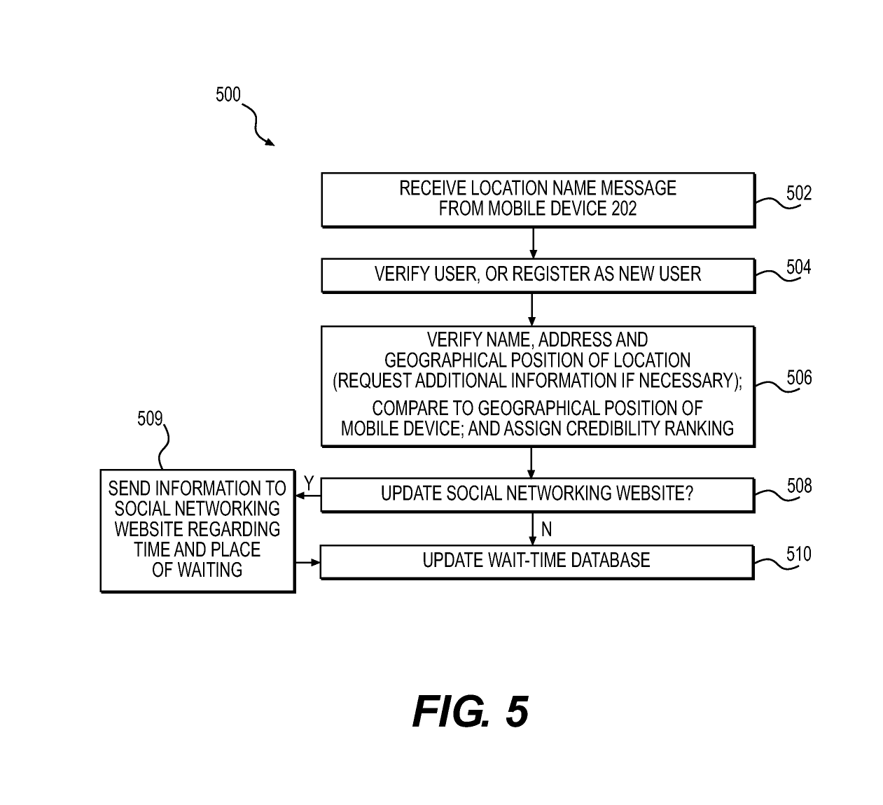

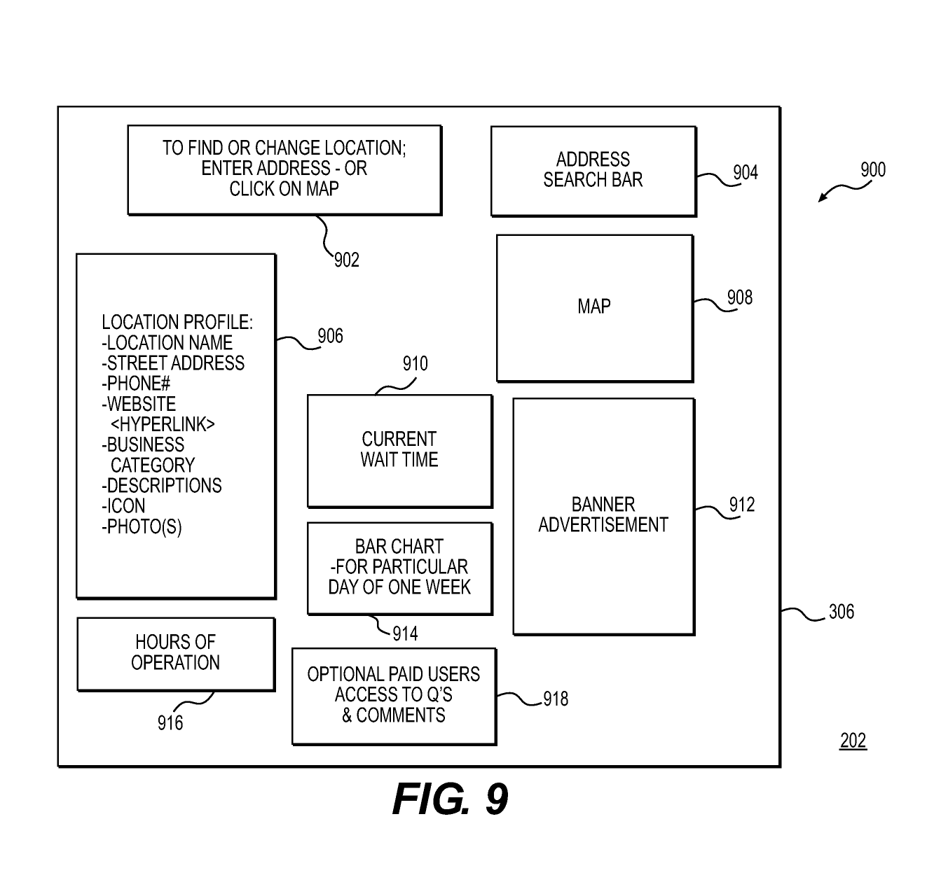

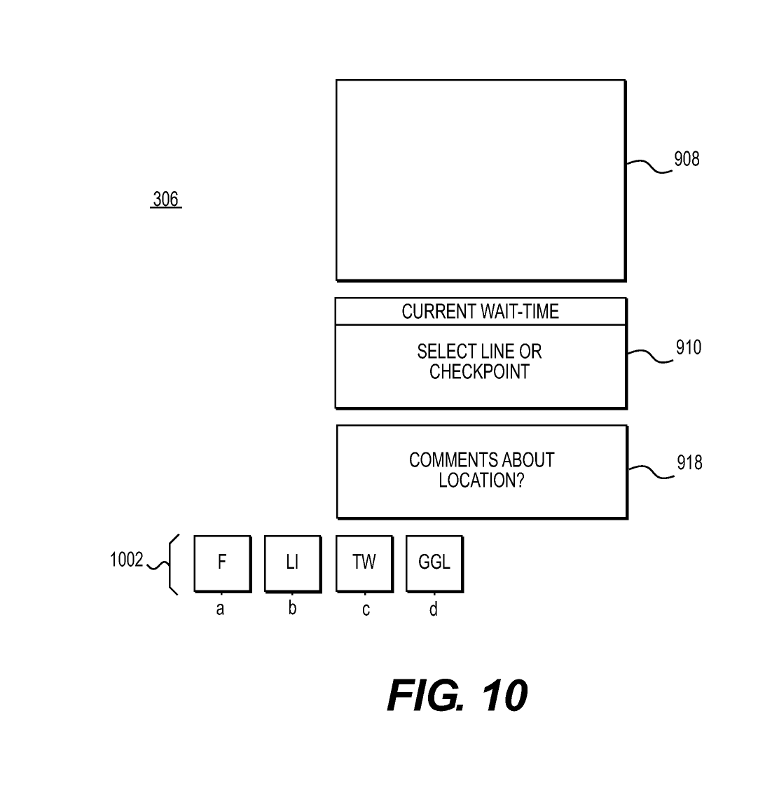

Method 400 illustrates in one manner how substantially accurate and near-real time wait-time information can be provided to WaitIQ server 212 according to embodiments. Method 400 typically resides or can be implemented in the form of software code, as WaitIQ App 320, within a memory location within mobile device 202 according to methods and apparatus known to those of skill in the art. According to aspects of the embodiments, all or portions of method 400 can be embodied in the form of WaitIQ App 320. Method 400 begins with step 402 wherein WaitIQ App 320 asks the user to enter the name of the location. A screen display is presented on display/data entry unit 306 of mobile device 202 requesting the user to input their geographical position. FIG. 9, which illustrate a first view of display 306 on mobile device 202, and FIG. 10, which illustrates a detailed view of the wait-time information provided by WaitIQ App 320, are discussed below in greater detail according to an embodiment. According to an embodiment, only the name of the location can be requested. That is, according to an embodiment, it can be the case that just the name alone is enough to positively identify the location as either public location (e.g., restaurant, bar, arena, among others) or a private location (such as celebrity's residence, or semi-public location, such as an art gallery, among others). Once entered, the name of the location is transferred to WaitIQ server 212 along with position information of mobile device 202, as discussed above, and processed there, which is described in greater detail in regard to FIG. 5. The name of the different location and geographical location information of mobile device 202 is contained in a location name message. WaitIQ server 212 opens a new file when it receives the location name message, and a log is started to track the wait-time. WaitIQ server 212 then attempts to verify the name of the location (i.e., is it a real place, with an identifiable geographical location) by accessing one or more databases, including, but not limited to the internet, any websites that might be associated with the location name, telephone books, Dunn & Bradstreet, and other search engines, whether for free or by a paid subscription, among other sources. If WaitIQ server 212 cannot verify the name of the location, it can request additional information, in optional step 404, such as landmarks, street and city address, zip code, GPS coordinates, or any combination thereof.

In method step 406, method 400 asks the user to enter wait-time information. According to aspects of the embodiments, there are numerous ways in which substantially accurate and near real-time wait time information can be ascertained and entered in step 404 of method 400 to be stored on Wait IQ server 212, and/or to be used immediately by the user. Although five main categories are shown in FIG. 4, those of skill in the art can appreciate that this is not an exhaustive list, and that according to further embodiments, other methods, considered to be within the aspects of the embodiments, can be used to determine and enter the wait-time information.

According to a first aspect of the embodiments, a first manner of ascertaining the wait-time information can be done by the user after waiting in line at the location. That is, the user arrives at some location (for example, a restaurant, but not limited thereto), provides a name for the wait list to the restaurant hostess, and waits until seated. Then the user remembers to access WaitIQ App 320, and using method 400 according to embodiments, enters the wait time information the user just experienced.

According to a second aspect of the embodiments, a second manner of ascertaining the wait-time information can be done by the user through use of a stopwatch feature of WaitIQ App 320, or of their mobile device 202. Using the non-limiting example of waiting in line for a table at a restaurant, as the user provides a name to the hostess at the restaurant, the user access WaitIQ App 320 and starts the timer function. Periodically, WaitIQ App 320 will check with the user as to whether timing should continue, to try and prevent the user from forgetting to complete the action of entering and transferring the wait-time information to WaitIQ server 212. Periodically, method 400 can ask the user if the wait period has expired, and can, in the case of extremely long wait periods, ask the user to verify if he or she is still actually waiting. Or, method 400 can curtail the wait-timer after an arbitrary wait period that might be dependent upon the location. When the user eventually is seated, the user can complete or terminate the timer action, and the substantially accurate, in near real time wait-time information can be transferred to WaitIQ server 212 without any further action required by the user.

According to a further embodiment, another method for obtaining substantially accurate and near real time wait-time information is through the use of third-party provided wait-time information. That is, a user can ask someone—e.g., a person who has been waiting in line, a friend who has already waited in line, a person connected with the location (e.g., the hostess/owner)—and obtain the wait-time information in that manner. The third party provided wait-time information can be based on an actual wait-time experienced by that third-party, or it can be an estimated wait-time. The user can then enter the third-party provided wait-time information into WaitIQ App 320 that then causes it to be transferred to WaitIQ server 212. According to further embodiments, WaitIQ App 320 can ask how the wait-time information was acquired, and WaitIQ server 212 can assign a reliability rating to it, using other previously acquired wait-time information, or currently acquired wait-time information, or historic wait-time information, or by other means, and use that reliability rating in wait-time processing algorithms to prepare wait-time information for other users.

According to a further embodiment, a first user can access the map (shown in FIG. 9) and click on a location of interest (by way of non-limiting example, a restaurant); WaitIQ App 320 will show the first user that a second user of WaitIQ App 320 is on site (anonymously). The first user can then request of the second user to update the wait time via a private message through a special feature within WaitIQ App 320. WaitIQ App 320 will have a few basic questions that users can send to each other such as “What is the current Wait Time?” The second user on location can respond by selecting the current wait time and sending that information back to the first user.

According to still a further embodiment of providing substantially accurate near real time wait-time information, the user can estimate the wait-time on their own when they view the line and/or crowd waiting to enter/use the location. According to an embodiment, WaitIQ App 320 can again ask how the wait-time information was acquired, and WaitIQ server 212 can assign a reliability rating to it, using other previously acquired wait-time information, or currently acquired wait-time information, or historic wait-time information, or by other means, and use that reliability rating in wait-time processing algorithms to prepare wait-time information for other users.

According to still a further embodiment of providing substantially accurate near real time wait-time information, the user can access a special feature of WaitIQ App 320, or it can automatically be activated, that allows the use of NFC/BT/GPS/Wireless positioning determination information to determine the wait-time information. As those of skill in the art can appreciate, GPS position determinations are generally most reliable when the user is outdoors, due to the nature of the satellite signals. In this manner of determining wait-time information, the user would enable a GPS-determined wait-time information mode in WaitIQ App 320 and if mobile device 202 was so equipped it would determine its position using a GPS position determination application at the beginning of the line and the end of the line and calculate the time/distance differential, thereby creating the wait-time information The cellular wireless positioning determination works in substantially the same manner, but uses one of the many cellular signal position determining processes available and known to those of skill in the art.

By way of a non-limiting example, if, for example, a natural disaster were to occur, thousands of people could show up and wait in line. Through use of GPS coordinates, the position of a person can be tracked as they go through the line. By measuring the length of the line (½ mile or 2640 feet), the wait time and distance can be measured by GPS. As known to those of skill in the art, depending on the urban setting GPS can be accurate between about a 1 meter and about 20 meters. A federal emergency management agency (FEMA) worker could setup the location information and mark it as a GPS waypoint. If a user shows up and they have WaitIQ App 320 open it can tell them how far away from the way point they might be. A user can show up at the location and realize that the line is ½ mile long. WaitIQ App 320 can then ask if there is more than one line, or is it a single file line? Or are there multiple lines? Thus, according to embodiments, WaitIQ App 320 and WaitIQ server 212, and the software stored thereon, can process the wait-time information and other data provided by one or more users of WaitIQ App 320, to determine a wait-time, the number of people in line, the total distance of the line, and how many people have been processed in total, and how many people have been processed per-hour (or some other time increment).

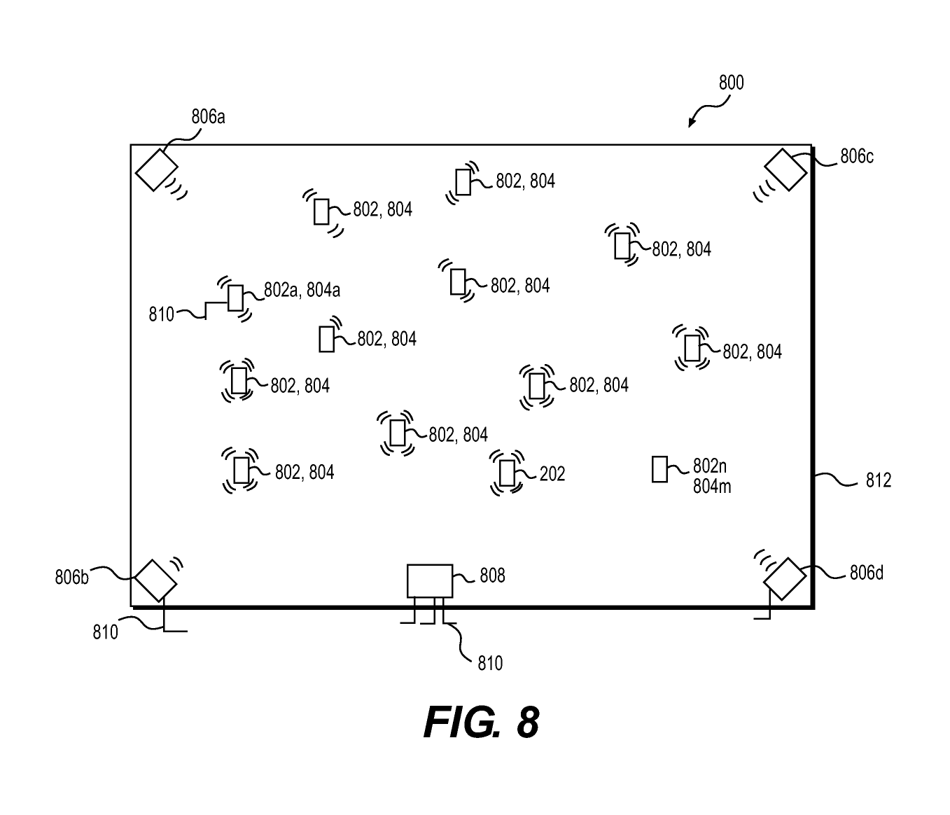

According to a further embodiment, and as shown in FIG. 8, short distance position determining system 800 can be used to determine a position of a user as the user enters a line, and using position determining processes known to those of skill in the art, can acquire and transmit wait-time information either automatically, or via an interactive mode of WaitIQ App 320. Regardless of how short distance positioning determining system 800 is used by the user (automatically/manually), the substantially accurate near real time wait-time information is acquired by WaitIQ App 320, and transferred to WaitIQ server 212 for use therein, as described above and below according to embodiments.

As can be appreciated by those of skill in the art, the term “short distance” is relative; that is, compared to a GPS positioning determining system, or a cellular phone network positioning determining system, the types of components used in short distance positioning determining system 800 is generally limited to about 100 meters or less (BT has three classes, class 1 can communicate successfully to about 100 meters, class 2 10 meters, and class 3 about 1 meter; Wi-Fi can communicate up to about 100 feet or so, and NFC devices in the order of about 10 feet or so). The number and placement of Wi-Fi transceivers 806, BT transceivers 802, and NFC transceivers 804 is determined by the size of the area to monitor, and any natural or artificial impediments to the signal(s) within location 812.

Presuming that a user has WaitIQ App 320 on their mobile device 202, and it is either opened, or automatically enabled, as soon as it encounters location 812 that includes short distance positioning determining system 800, it will begin communicating with short distance positioning determining system 800 using one or more of transceivers 802, 804, 806, register position/time, and track the movement of the user with the WaitIQ App 320 in mobile device 320 as it moves within location 812. Signals and data are received, stored, and transmitted by location server 808 via server cables 810. As those of skill in the art can appreciate, some commercially available products exist that use one or more of NFC, BT and Wi-Fi signals to determine position of people within stores, for example. These include i-beacon, among others.

In method step 408, method 400 causes mobile device 202 to transfer the wait-time information to WaitIQ server 212 once the timer is shut off, times out, or immediately after the wait-time information was entered in step 404. Once the wait-time information has been transferred to WaitIQ server 212, methods embodied as code therein begin to process the wait-time information to create searchable and reportable records, which are discussed in greater detail below.

FIG. 5 illustrates a flow diagram illustrating method 500 of maintaining wait-time information according to an aspect of the embodiments. An encoding process is discussed with reference to FIG. 5. This encoding process is not meant to limit the embodiments, nor to suggest that any particular embodiment should be implemented following this encoding process. The purpose of the following encoding process is to facilitate the understanding of an embodiment and to provide the reader with one of many possible implementations of the processes discussed above. FIG. 5 shows a flow chart illustrating various steps performed during the encoding process. The steps shown in FIG. 5 are not intended to completely describe the encoding process but only to illustrate some of the aspects discussed above, nor should they be construed to indicate that any particular order of steps needs to occur, unless otherwise so indicated.

Method 500 ostensibly begins after method 400 has begun, or finished, but in a practical sense, according to further embodiments, additional data processing of “raw” wait-time information can occur independently of operation of method 400. Method 500 begins with step 502, in which a location name message from mobile device 202 is received, along with mobile device 202 location information. WaitIQ server 212 uses the location name as a header, or file name, in order to track the data later when compiling wait-time information and determining certain statistics. In step 504, method 500 determines whether the user is a known and registered user, or not. location name message will contain mobile device 202 identification information (such as phone number, IP address information, email information, and the like) and method 500 processes the same to determine whether the user is a known user of Wait-TimeIQ, or is a new user, in which case registration can ensue according to an embodiment. Registration can also be delayed to a later time, or conducted at that time, according to methods known to those of skill in the art. According to a further embodiment, the system and method for providing wait-time information can accept wait-time information without having registered users. However, as known to those of skill in the art, registration will generally occur when WaitIQ App 320 is first downloaded onto a user's mobile device 202.

Once the location name message is received by WaitIQ server 212, regardless of status of registration of the user, a new file is opened, and then method step 500 performs method step 506, wherein a verification of the address of the location occurs and is attempted to be matched to the location information of mobile device 202. WaitIQ server 212 includes additional processing algorithms that assist in determining or verifying the actual location of the user, based on the name of the location, GPS coordinates, or cellular-system provided geographical position information. Initially, WaitIQ server attempts to find geographical position information on the location based on its name alone; if it can, it then compares that to the geographical position information of mobile device 202 and if they match, it assigns a location-mobile device geographical position match ranking. This ranking can be on the scale of 1-10, with 10 being the highest according to an embodiment. As those of skill in the art can appreciate, such ranking is but one example, and is not meant to be taken in a limiting sense.

If WaitIQ server 212 and method 500 cannot ascertain geographical position information of the location based on name alone, it might try and find an associate website and obtain the location information that way, or it may request additional information from the user, such as the address, or as much information as the user can provide (street name, number, zip code, GPS coordinates), as well as other information, such as proximity to other nearby identifiable buildings, locations, and landmarks (e.g., rivers, harbors, among others), and the like. WaitIQ server 212 and method 500 then compares location information again, and ranks this information according to a predefined and predetermined ranking scale. Depending on the ranking, WaitIQ server 212 can store the information, but may not present it to other users unless and until it can be reliably verified, or may use it in a different manner, according to further embodiments.

Method 500 can then perform optional step 508 wherein the user is queried as to whether a social networking site of the user should be updated. The option to update a social network site can be determined as part of the registration process discussed in greater detail below. That is, once the address and name of the location has either been verified, or not, a social networking site (e.g., Facebook®) that the user is a member of can be updated with a posting that tells the friends of the user where the user is and what they are doing (“Yes” path from decision step 508). This message can be automatically generated by the name and other information of the location. For example, if a user is waiting in line to dine out at Chipotle®, a well-known Mexican food restaurant, a posting could be “20 Minute Wait Time at Chipotle in Reston, Va.—via Waitiq.com!!” Ostensibly, other friends of the users could then decide to join them. Or, if the user has not chosen the social networking update feature, or does not wish to have the social networking website updated at that particular time (“No” path from decision step 508), method 500 proceeds to step 510.

In method step 510, method 500 then waits to receive the actual wait-time information. At some point, WaitIQ App 320 on mobile device 202 will forward either manually entered wait-time information, wait-time information determined from a timer, or timed-out wait-time information; in general, the wait-time information can be generated in any manner as discussed above in regard to FIG. 4, method 400, and step 406 according to an embodiment. The received wait-time information, which can be actual wait-time information as determined by a person who has done the waiting, is then stored in a WaitIQ database in method step 508. Furthermore, such wait-time information is available immediately or nearly immediately to others that access the WaitIQ server 212 (as discussed in greater detail below), and in near real-time. As those of skill in the art can appreciate, wait-time information that has been predicted or generated by an algorithm can be of some (albeit lesser) value, what is of infinitely greater value is what someone is experiencing at that moment in time; crowds can appear at a moment's notice, or just as quickly disperse, and predicted or historic wait-time information, while of some limited use, is just not the same as actual, near real-time wait-time information.

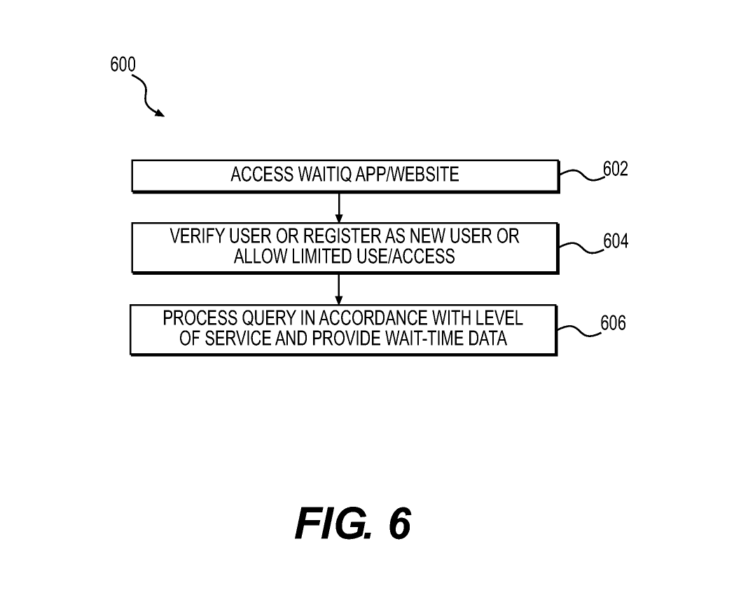

FIG. 6 illustrates a flow diagram illustrating method 600 of accessing wait-time information maintained according to the method of FIG. 5 by a user of mobile device 202 in a non-limiting example according to an embodiment. An encoding process is discussed with reference to FIG. 6. This encoding process is not meant to limit the embodiments, nor to suggest that any particular embodiment should be implemented following this encoding process. The purpose of the following encoding process is to facilitate the understanding of an embodiment and to provide the reader with one of many possible implementations of the processes discussed above. FIG. 6 shows a flow chart illustrating various steps performed during the encoding process. The steps shown in FIG. 6 are not intended to completely describe the encoding process but only to illustrate some of the aspects discussed above, nor should they be construed to indicate that any particular order of steps needs to occur, unless otherwise so indicated. Prior to beginning the discussion of FIG. 6 and method 600 according to an embodiment, FIGS. 9 and 10 will be discussed.

FIGS. 9 and 10 illustrate, respectively, different screen shots that can be displayed on mobile device 202 used to enter or access substantially accurate, and in near real time wait-time information according to an embodiment. FIG. 9 illustrates a first view 900 of display 306 on mobile device 202, and FIG. 10 illustrates a second view of display 306 when a desired location has been selected, are discussed below in greater detail according to an embodiment. In FIG. 9, display 306 includes several graphical user interface (GUI) objects that are caused to be displayed as the result of processing of several different encoded programs, the details of which are not necessary to understand the different and various aspects of the embodiments. The creation of these user interfaces between the methods embodiment in the form of programs within mobile device 202 and the user are well known, although the aspects of the embodiments encoded therein are both novel and an unobvious. Thus, a detailed description of the encoding process for the creation of the GUIs have been omitted in fulfillment of the dual purposes of clarity and brevity.

View 900 of display 306 includes enter location information banner object 902, location address search GUI 904, location profile GUI 906, map GUI 908, current wait time object 910, advertisement banner GUI 912, wait-time bar chart GUI 914, hours of operation of location GUI 916, and additional details GUI 918, according to aspects of the embodiments. Each will be discussed in turn.

Enter location information banner object (banner object) 902 is simply a banner that is displayed once WaitIQ App 320 opens up on mobile device 202, and directs the user as to what to do; for example, according to an embodiment, banner object 902 can direct the user to find or change location to enter an address in location address search box GUI 904, or click on map GUI 908. In the former case, the user clicks on address search box GUI 904, enters the address information of the desired location to the best of their ability, and then clicks on a search button (not shown), or tries to find the geographical position of the desired location on the map GUI 908. WaitIQ server 212 can then search for and find details about the desired location. These manners of searching for position information are known to those of the skill in the art, and need no further discussion.

Location profile GUI 906 provides or presents to the user the detailed information about the desired location if it is available to, or stored on WaitIQ server 212; as discussed above and below WaitIQ server 212 can access its own database, or other databases that might be available via other means and services to find the location profile information (websites, Dunn & Bradstreet, state corporate offices, among others).

Current wait time object 910 shows the user the current wait-time information that WaitIQ server 212 has stored for the desired location. WaitIQ server 212 might not have any wait-time information for a new location, or it could have a significant amount of data to analyze and provide in a useful format to the user. According to a further embodiment, a different class of users (e.g., users that have paid a fee, or an extra fee) can access further information, such as creating multiple checkpoints or checking multiple lines for the desired location.

Multiples lines for a desired location can include, for example, different lines at different bathrooms in a stadium complex, or arena, or lines to get into a parking lot. Each line can have a unique name (e.g., level 1, restroom facilities 3) so that a person deciding to visit such facility can now make a more accurate determination as to whether which is the best line to get into. This can include such factors as whether it makes sense to walk around the facility to get to a line that might seem shorter, or which has historically been shorter. Now, the user has accurate wait time information apriori, and can make a better decision about how to use their time resources. Multiple checkpoints incorporates the situation wherein a line has formed, but for some reason splits into more than one separate termination or mid-points, then reforms or terminates. An example could be an air transit safety administration (TSA) security checkpoint when accessing a terminal. The line is generally combined in the beginning, but splits up; a user can attempt to access the line wherein the more efficient security screeners are processing travelers more quickly.

Advertisement banner GUI 912 provides a means for the owner/operator/licensee of WaitIQ server 212 and/or WaitIQ App 320 to generate revenue in a manner that is well known to those of skill in the art. Advertisement banner GUI 912 can be interactive, to allow users the ability to use a hyperlink to access the website of the advertising company, and purchase products, find additional information, or get coupons that are related to the desired location.

Wait-time bar chart GUI 914 provides a drop down menu that allows the user to change a report view for a different day of the week. That is, according to a non-limiting example, if the user attempts to find wait-time information on Thursday afternoon for a fairly well known restaurant, but is actually intending to go on Friday, and is just in the process of making plans, the user can use a drop down menu to find the wait-time information for a different day of the week, in this case Friday, and can plan accordingly. Hours of operation of location GUI 916 provides the times and dates of operation of the desired location, and can note special opening and closing times based on special calendar events, such as holidays, or weather related incidents. Additional details GUI 918 provides specially obtained and prepared information for the aforementioned different class of users; in this case, the special information can be in the form of frequently asked questions and answers, and things of that nature according to an embodiment.

FIG. 10 illustrates a second view of display 306 when a desired location has been selected and additional information that can be made available for the different class of users. In FIG. 10, map 908 is displayed, showing the geographical position of the desired location, and current wait-time object 910 is displayed showing the choices available to the different class of users who can select multiple lines or checkpoints. The user can enter or access additional information in additional details GUI 918, which provides specially obtained and prepared information for the aforementioned different class of users; in this case, the special information can be in the form of frequently asked questions and answers, and additional items of that nature according to an embodiment. Buttons 1002a-d provide access points according to an embodiment for the user to update the social media outlet of choice (Facebook, Twitter, Linked-in, Googl+, among others) on their current activity, such as waiting in line at the desired location.

Method 600, which can reside in mobile device 202, or PC/laptop 104 (from hereon in, however, for the sake of brevity and clarity, use of mobile device 202 alone will be discussed though one of skill of the art can appreciate that use of method 600 is not limited thereto), begins with step 602 wherein a user access the WaitIQ App 320, which in turn accesses WaitIQ server 212, and the identification of the user is verified in step 604. If the user is not known, the user can be registered according to well-known methods (email address, password generation, email address verification, among other steps), the detailed discussion of which has been omitted in fulfillment of the dual purposes of clarity and brevity. As discussed above, one additional optional registration feature can be the updating of one or more social networking sites that the user participates in. The user can be asked if they participate, and if yes, request their user name and password information for each social networking site.

Following the determination of whether the user is known, or is now registered, method 600 presents a screen, whether through the use of WaitIQ App 320 or the website, to the user with data entry points that asks what location the user is interesting in attending, date, and time. WaitIQ server 212 then accesses its database for historical wait-time information, as well as any recently reported wait-time information (i.e., last hour, two hours, four hours, past 24 hours; these are all but examples, and are not meant to be taken in a limiting manner), and presents this to the user. As described above, actual, near real-time wait-time information is valued by users and according to an embodiment can be presented in such a manner as to be highlighted over the historical data. If the wait-time information is not available or to the liking of the user, a different location can be chosen. The user can then make an intelligent, informed decision as to which, if any, location to attend or visit at that time, thus conserving perhaps the most precious commodity of all, time.

FIG. 7 illustrates a functional block diagram of WaitIQ server 212 showing various functional blocks according to an embodiment. WaitIQ server 212 can include the following functional blocks according to an embodiment: communications interface—message processing block (communication block) 702, authorization/registration block 704, verification of location block 706, wait-time database 708, and wait-time report generator 710. Such functionality is embodied in one or more processors, accessing one or more different types of memory, wherein can be stored code, or software, in which the different functional aspects can be realized by “running” the code and receiving and processing data, including, for example, location name and geographical position information, registration and user name information, and wait-time information.

Upon receipt of a communication from, by way of a non-limiting example, mobile device 202 or PC 204, communication block 702 receives and processes the message and determines which functional block needs to receive it to act upon it. The message could be, for example, a new registration (from a potential user who has decided to download WaitIQ App 320 onto their PC 204 and/or mobile device 202), an inquiry about a location, or wait-time information to be added to the wait-time database 708. Communication block 702 recognizes the type of message and forwards it as appropriate.

In a first instance, the received message could be a registration message to register a new user. In that case, communication block forwards the message and its information to authorization/registration block 704. Authorization/registration block 704 receives the information, and processes it accordingly, generating follow-up messages to the new user as appropriate and stores the registration information in a user-information database. Or, if the received message purports to be from a registered user, authorization/registration block 704 attempts to verify the same, and sends follow up message(s) to the user to either verify or obtain additional information. For example, considering the multiple passwords many people have, many times they are forgotten, and the user will need to reset it, usually by receiving an email at their known email address, which is routine activity and process known to those of skill in the art.

Communication block 702 can also receive a message that it will recognize as a query message to verify the name and/or address of a location. In that case, communication block 702 will forward the message to verification of location block (verification block) 706, which can use, according to an embodiment, its own database of location information, yellow or white pages websites, GPS data databases, among other sources, in an attempt to verify the name and geographical position of the location. Verification block 706 can then generate messages to be sent to the user attempting to enter wait-time information in order to verify the name and geographical position of the location, as discussed in greater detail above.

Communication block 702 can also receive a message the contains near real-time, and substantially accurate wait-time information according to an embodiment. Communication block 702 can then forward this message with the wait-time information to wait-time database 708 which stores it in an appropriate location, and performs other database functions as is well known to those of skill in the art. Wait-time database 708 stores new wait-time information, and provides stored wait-time information to wait-time report generator 710 in response to queries.

Communication block 702 can also receive wait-time report generation queries from users that it will then forward to wait-time report generator 710. Wait-time report generator 710, upon receipt of the wait-time query, will verify that the location exists in its wait-time database 708, and if it cannot match it directly, will attempt to do so by generating questions for the user. Once wait-time report generator 710 is satisfied that it has the correct location, it will find whatever data it needs from wait-time database 708 in order to create the wait-time report requested of it. According to further embodiment, these reports can include, by way of non-limiting example only, histograms based on the day of the week where the chart consists of the average wait-time by the time of the day. In addition, reports can be provided that show how many people are waiting in line where the data is gathered from other users in line. This can also be in the form of a histogram chart. According to further embodiments, the type of report generated, or the level of detail, can be affected by the type of device that the report is being sent to. For example, a wait-time report that includes a significant amount of graphics may not display well on a smart phone, so wait-time report generator 710 can re-fashion the data into a more manageable format for the use of mobile device 202 that requested the wait-time report.

According to an embodiment, implementation of methods 400, 500, and 600 can occur in one or more dedicated processors (e.g., as shown in FIGS. 2, 3, and 7), or through the various functional blocks shown in FIGS. 3 and 7 as position determining unit 308, message processing block 702, authorization/registration block 704, verification of location block 706, wait-time database 708, and wait-time report generator 710. Those of ordinary skill in the art in the field of the embodiments can appreciate that such functionality can be designed into various types of circuitry, including, but not limited to field programmable gate array structures (FPGAs), application specific integrated circuitry (ASICs), microprocessor based systems, among other types. A detailed discussion of the various types of physical circuit implementations does not substantively aid in an understanding of the embodiments, and as such has been omitted for the dual purposes of brevity and clarity. However, as known to those of ordinary skill in the art, the systems and methods discussed herein can be implemented as discussed, and can further include programmable devices.

Such programmable devices and/or other types of circuitry as previously discussed can include a processing unit, a system memory, and a system bus that couples various system components including the system memory to the processing unit. The system bus can be any of several types of bus structures including a memory bus or memory controller, a peripheral bus, and a local bus using any of a variety of bus architectures. Furthermore, various types of computer readable media can be used to store programmable instructions. Computer readable media can be any available media that can be accessed by the processing unit. By way of example, and not limitation, computer readable media can comprise computer storage media and communication media. Computer storage media includes volatile and nonvolatile as well as removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by the processing unit. Communication media can embody computer readable instructions, data structures, program modules or other data in a modulated data signal such as a carrier wave or other transport mechanism and can include any suitable information delivery media.

The system memory can include computer storage media in the form of volatile and/or nonvolatile memory such as read only memory (ROM) and/or random access memory (RAM). A basic input/output system (BIOS), containing the basic routines that help to transfer information between elements connected to and between the processor, such as during start-up, can be stored in memory. The memory can also contain data and/or program modules that are immediately accessible to and/or presently being operated on by the processing unit. By way of non-limiting example, the memory can also include an operating system, application programs, other program modules, and program data.

The processor can also include other removable/non-removable and volatile/nonvolatile computer storage media. For example, the processor can access a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the operating environment of the embodiments include, but are not limited to, magnetic tape cassettes, flash memory cards, digital versatile disks, digital video tape, solid state RAM, solid state ROM and the like. A hard disk drive can be connected to the system bus through a non-removable memory interface such as an interface, and a magnetic disk drive or optical disk drive can be connected to the system bus by a removable memory interface, such as an interface.

The present embodiments can also be embodied as computer-readable codes on a computer-readable medium. The computer-readable medium can include a computer-readable recording medium and a computer-readable transmission medium. The computer-readable recording medium is any data storage device that can store data which can be thereafter read by a computer system. Examples of the computer-readable recording medium include read-only memory (ROM), random-access memory (RAM), CD-ROMs and generally optical data storage devices, magnetic tapes, flash drives, and floppy disks. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to, when implemented in suitable electronic hardware, accomplish or support exercising certain elements of the appended claims can be readily construed by programmers skilled in the art to which the embodiments pertain.

The above-described embodiments are intended to be illustrative in all respects, rather than restrictive, of the embodiments. Thus the embodiments are capable of many variations in detailed implementation that can be derived from the description contained herein by a person skilled in the art. No element, act, or instruction used in the description of the present application should be construed as critical or essential to the embodiments unless explicitly described as such. Also, as used herein, the article “a” is intended to include one or more items.

All United States patents and applications, foreign patents, and publications discussed above are hereby incorporated herein by reference in their entireties.

We claim:

1. A method for providing wait-time information regarding a location by a user, the method comprising:
determining an actual wait-time experienced at the location by the user;
reporting the actual wait-time using a wait-time reporting software application (App) substantially soon after a waiting period has ended to a wait-time server by the user using a mobile communication device upon which is stored the wait-time reporting software App; and
providing the actual wait-time by the mobile communications device to one or more requestors upon request to their respective one or more electronic devices.

2. The method according to claim 1, wherein the step of determining an actual wait-time comprises:
estimating the wait-time waiting at the location.

3. The method according to claim 2, wherein the step of estimating an actual wait-time comprises:
estimating a wait-time by the user before experiencing the wait-time.

4. The method according to claim 2, wherein the step of estimating an actual wait-time comprises:
estimating a wait-time by the user after experiencing the wait-time.

5. The method according to claim 2, wherein the step of estimating an actual wait-time comprises:
obtaining an estimated wait-time provided by another person before the another person has experienced the wait-time.

6. The method according to claim 2, wherein the step of estimating an actual wait-time comprises:
obtaining an estimated wait-time provided by another person after the other person has experienced the wait-time.

7. The method according to claim 1, wherein the step of determining an actual wait-time comprises:
starting a timer at a beginning of the wait-time using the mobile electronic communication device; and
stopping the timer at an end of the wait-time.

8. The method according to claim 1, wherein the step of determining an actual wait-time comprises:
obtaining an actual wait-time experienced by another person.

9. The method according to claim 1, wherein the step of determining an actual wait-time comprises:
determining the wait-time based on a change in a geographical position as determined by geographical position information generated by a geographical position determining system and provided to the wait-time reporting software App stored on the user's mobile electronic communication device, wherein the wait-time reporting software App is configured to calculate an actual wait-time based on the geographical position information provided by the geographical position determining system.

10. The method according to claim 9, wherein
the geographical position determining system is one based on at least one of a near field communications system, a Bluetooth communications system, and a Wi-Fi communications system.

11. The method according to claim 9, wherein
the geographical position determining system is one based on at least one of a global positioning system, and a cellular phone network system.

12. A system for providing wait-time information regarding a location by a user, the system comprising:
a first mobile electronic communications device containing a wait-time reporting software application (App) configured to capture and transmit actual wait-time information at the location substantially soon after a waiting period has ended;
a second electronic device configured to receive the actual wait-time information and store the same, and wherein
the second electronic device is further configured to provide the actual wait-time information upon request.

13. The system according to claim 12, wherein
the actual wait-time comprises an estimation of the wait-time while waiting at the location.

14. The system according to claim 13, wherein
the estimated wait-time is estimated by the user before experiencing the wait-time.

15. The system according to claim 13, wherein
the estimated wait-time is estimated by the user after experiencing the wait-time.

16. The system according to claim 13, wherein
the estimated wait-time is provided by another person before the another person has experienced the wait-time.

17. The system according to claim 13, wherein
the estimated wait-time is provided by another person after the another person has experienced the wait-time.

18. The system according to claim 12, further comprising:
a timer configured to be used with the mobile electronic communications device, wherein the use can start the timer at a beginning of the wait-time and stop the timer at an end of the wait-time.

19. The system according to claim 12, wherein
the actual wait-time is obtained from another person after the another person has experienced the wait-time.

20. The system according to claim 12, wherein
the actual wait-time is determined based on a change in a geographical position as determined by geographical position information generated by a geographical position determining system and provided to a wait-time reporting software App stored on the user's mobile electronic communication device, wherein the wait-time reporting software App is configured to calculate an actual wait-time based on the geographical position information provided by the geographical position determining system.

21. The system according to claim 20, wherein
the geographical position determining system is one based on at least one of a near field communications system, a Bluetooth communications system, and a Wi-Fi communications system.

22. The system according to claim 20, wherein
the geographical position determining system is one based on at least one of a global positioning system, and a cellular phone network system.

23. A method for operating a wait-time information distribution service, the method comprising:
receiving one or more location name messages from one or more electronic devices, wherein each of the one or more location name messages contains at least a location name of a first location where a user is or will be waiting;
verifying the location name and geographical position of the location through one or more of a location name database stored on the wait-time server and other electronically accessible searchable databases;
receiving and storing actual wait-time information from one or more of the electronic devices regarding respective same or different locations;
receiving a request by an electronic communications system to access the wait-time server to obtain a desired wait-time information about a first location; and
providing the desired wait-time information about the first location to the requestor using the electronic communications system.

24. The method according to claim 23, further comprising:
verifying the location name and geographical position of the location through one or more of a location name database stored on the wait-time server and other electronically accessible searchable databases; and
determining a registration status of a user of the one or more electronic devices with the wait-time server from which the one or more location name messages has been received, and if not registered, determining whether registration is desired.

25. The method according to claim 23, further comprising:
determining whether a social networking website should be updated when the wait-time information is received from a registered user of the wait-time information distribution service.

26. A wait-time information distribution service comprising:
one or more electronic devices configured to provide one or more location name messages, wherein each of the one or more location name messages contains at least a location name of a first location where a user is or will be waiting; and
a wait-time information distribution server configured to
verify the location name and geographical position of the location through one or more of a location name database stored on the wait-time server and other electronically accessible searchable databases,
receive and store actual wait-time information from the one or more of the electronic devices regarding respective same or different locations,
receive a request using an electronic communications system to access the wait-time server to obtain a desired wait-time information about a first location, and
provide the desired wait-time information about the first location to the requestor using the electronic communications system.
